(19) United States
(12) Patent Application Publication
(10) Pub. No.: US 2026/0329284 A1
(43) Pub. Date: Oct. 22, 2026

(54) DECENTRALIZED ENCOUNTER-BASED SHARING OF SEMANTIC HAZARD DATA IN A HETEROGENEOUS PHYSICAL ARTIFICIAL INTELLIGENCE (AI) SWARM

(71) Applicant: Dorian Cartwright, San Jose, CA (US)

(72) Inventor: Dorian Cartwright, San Jose, CA (US)

(21) Appl. No.: 19/654,952

(22) Filed: Apr. 22, 2026

(51) Int. Cl. G05D 1/246; G05D 1/622; G05D 101/00; G05D 109/12; G06F 16/29; H04W 4/70

(52) U.S. Cl. CPC G05D 1/2467; G05D 1/622; G06F 16/29; H04W 4/70; G05D 2101/24; G05D 2109/12

(57) ABSTRACT

Decentralized sharing of environment data between autonomous robots includes detecting a physical hazard, assigning a semantic label to the hazard, and storing the hazard as historical semantic map data. Upon detecting proximity to another robot in an environment lacking connectivity to a centralized server, the robot transmits the semantic map data via a peer-to-peer communication link. The receiving robot updates a local navigation model and modifies a planned route prior to encountering the hazard. Predictive hazard-aware navigation occurs without reliance on centralized infrastructure.

### FIELD OF THE INVENTION

The present disclosure relates generally to computers and physical artificial intelligence (AI), and more specifically, to decentralized peer-to-peer sharing of semantic environment data between autonomous robots to enable predictive hazard-aware navigation without reliance on centralized infrastructure, including without a central controller, central scheduler, or centralized server.

### BACKGROUND

Autonomous robots are increasingly deployed in environments such as warehouses, sidewalks, streets, air, water, campuses, industrial facilities, and outdoor delivery routes. In these environments, robots frequently encounter dynamic hazards including obstacles, terrain irregularities, debris, spills, or blocked pathways.

Conventional robotic systems rely heavily on centralized infrastructure, such as cloud-based mapping services or fleet-management servers, to aggregate and distribute environmental information. However, such centralized systems suffer from several limitations, including communication latency, bandwidth constraints, and dependence on continuous network connectivity. In many real-world deployments, robots may operate in environments with intermittent or nonexistent connectivity, rendering centralized coordination impractical or unavailable.

Accordingly, there exists a need for robust techniques enabling autonomous robots to share semantically meaningful hazard information directly with one another in a decentralized manner, particularly in environments lacking centralized communication infrastructure, such that receiving robots can proactively adjust navigation behavior prior to encountering hazards.

### SUMMARY

The present disclosure addresses these shortcomings with systems, methods and computer program products for decentralized sharing of semantic hazard map data between autonomous robots.

In one aspect, a first autonomous robot navigates along an environment and detects a physical hazard using onboard sensors. The first autonomous robot assigns a semantic label to the detected hazard and stores the hazard as historical semantic map data, including spatial coordinates associated with the hazard.

Upon detecting proximity to a second autonomous robot, the first autonomous robot establishes a local peer-to-peer communication link in an environment lacking connectivity to a centralized server. The first autonomous robot transmits at least a portion of the historical semantic map data directly to the second autonomous robot.

The second autonomous robot incorporates the received semantic hazard data into a local navigation model and modifies a planned route prior to encountering the hazard, thereby enabling predictive hazard avoidance without requiring local detection of the hazard.

In some embodiments, the data exchange is selectively triggered based on proximity thresholds, route overlap, or predicted traversal paths. In some embodiments, the transmitted data includes additional attributes such as hazard severity, confidence values, temporal validity, or recommended traversal constraints.

In certain embodiments, the encounter occurs between robots traveling along overlapping or reverse trajectories, enabling efficient propagation of hazard information along commonly traversed paths.

Advantageously, the disclosed system enables propagation of environmental knowledge across a robotic swarm without reliance on centralized infrastructure, thereby improving navigation efficiency, reducing redundant sensing, and enhancing operational robustness in dynamic and connectivity-limited environments.

### BRIEF DESCRIPTION OF THE DRAWINGS

The present disclosure will be understood more fully from the detailed description given below and from the accompanying drawings of various embodiments of the disclosure.

FIGS. 1A and 1B are perspective diagrams illustrating a pair (or swarm) of heterogeneous robots utilizing peer-to-peer communication for exchanging semantic mapping data while proximate, according to an embodiment.

FIG. 2 is a more detailed block diagram of an AI robot of FIG. 1, according to an embodiment.

FIG. 3A is a more detailed block diagram of a shared hazard data module of FIG. 2, according to an embodiment.

FIG. 3B is a more detailed block diagram of a physical AI platform of FIG. 2, according to an embodiment.

FIG. 4 is an example of a computing environment of system components, according to an embodiment.

FIG. 5 is a flow chart illustrating a method for exchanging semantic map data between heterogeneous robots during navigation, according to an embodiment.

FIG. 6 is a flow chart illustrating a method for building a local semantic map, according to an embodiment.

FIG. 7 is a flow chart for updating navigation based on shared mapping data from other robots, according to an embodiment.

### DETAILED DESCRIPTION

The present disclosure provides multi-robot systems, methods, and computer program products for propagating environment knowledge (e.g., environmental hazards). Unlike conventional approaches that rely on centralized map aggregation or continuous network connectivity, the disclosed system enables robots to exchange semantically meaningful hazard information directly when they come into proximity.

Conventional simultaneous localization and mapping (SLAM) techniques primarily construct geometric or probabilistic representations of an environment based on locally observed sensor data. While such systems may support map merging or loop closure, they generally do not encode semantically meaningful hazard abstractions that are transferable between robots for predictive navigation. Moreover, such systems typically assume either a shared global map or indirect synchronization through a backend system.

The disclosed semantic hazard-sharing system may operate in conjunction with, or as an input to, other decentralized swarm coordination mechanisms, including task allocation, load-sharing, spatial occupancy reservation, predictive actuation gating, policy enforcement, cooperative object handling, and multi-agent coordination. In some embodiments, the shared semantic hazard data functions as a distributed semantic state layer consumable by multiple downstream robotic subsystems while remaining logically distinct from bounded-region reservation-resolution logic and shared-load feasibility logic. Accordingly, a receiving robot may use shared semantic hazard data not only to modify a navigation route, but also to suppress, delay, decompose, reroute, or otherwise modify a candidate action, to select among alternative control policies, to determine whether a task remains feasible, to trigger reassignment of a task, or to adjust coordination behavior relative to other robots.

Although the disclosed semantic hazard data may be consumed by downstream subsystems for spatial reservation, predictive actuation gating, or cooperative object handling, the present disclosure is directed to propagation of semantic environment state between robots rather than to geometric reservation arbitration for bounded regions or to capability-based feasibility determination for shared-load transport. In this manner, the disclosed semantic hazard layer may function as a distributed semantic state substrate that is logically distinct from reservation-resolution logic and from cooperative load-sharing logic.

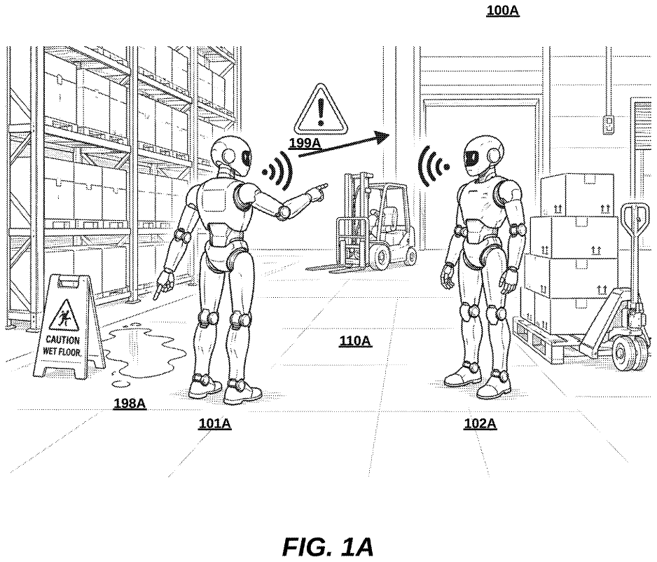

### I. System for Decentralized Semantic Hazard Propagation (FIGS. 1-4)

In FIGS. 1A and 1B, perspective diagrams illustrate systems 100A, 100B for decentralized semantic hazard propagation, according to an embodiment. The systems 100A, 100B include a first robot 101A, 101B and a second robot 102A, 102B in a commercial warehouse floor 110A and on a sidewalk 110B (e.g., last-mile delivery, industrial warehouse). There can be many more robots, for example, as part of a swarm. Additionally, the robots shown are delivery robots with wheels, but alternatively, can be humanoid robots (e.g., bipedal), aerial drones, submergible, or the like. The systems 100A, 100B can operate with or without network connectivity. In one embodiment, heterogeneous robots are completely independent machines of different vendors, tasks, and intents. In another embodiment, homogeneous robots are centrally connected over the Internet, and fallback to decentralized techniques disclosed herein during blind spots, weak or no connectivity, low network performance, and the like.

In an embodiment, the first robot 101A, 101B has successfully traversed a liquid spill 198A on the warehouse floor 110A and uneven pavement 198B on the sidewalk 110B using special procedures for that hazard, once identified. Later, and while within RF range, the first robot 101A, 101B can send semantic mapping data 199A, 199B to the second robot 102A, 102B. In response, the second robot 102A, 102B can update navigation routing to avoid the hazard 198A, 198B or can determine the hazard as traversable based on the specific hazard and onboard capabilities.

The liquid spill 199A and the uneven pavement 198B is a non-limiting example hazard, whereas additional embodiments have multiple uneven spots (e.g. side by side to completely block the sidewalk 110 rather than just partially block), different types of anomalies, and are located in a street, waterway, airway, warehouse floor, residential floor, or any appropriate type of terrain.

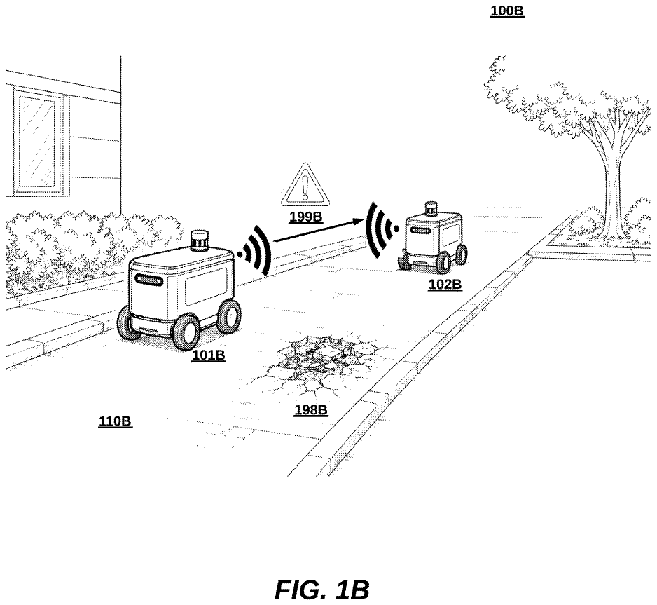

In FIG. 2, a block diagram illustrates internal components of a robot 200 (e.g., robots 101A, 101B, 102A, 102B), according to an embodiment. The robot 200 includes a workflow planning module 210 to set overall goals and tasks, a semantic analysis module 220 to process local hazard data specifically and semantic data in general, a shared hazard data module 230 to exchange hazard data, and a physical AI platform 240 to interact with the real-world environment.

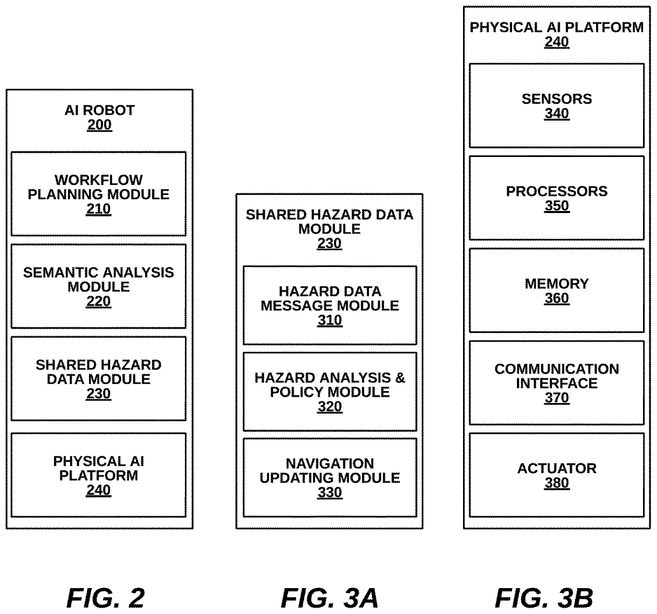

In FIG. 3A, the shared hazard data module 230 includes a hazard data message module 310 to exchange or at least receive hazard data, a hazard analysis and policy module 320 to locally process or at least preprocess received data, and a navigation updating module 330 to respond to hazards with rerouting, according to policy.

In some embodiments, the hazard analysis and policy module 320 provides semantic hazard outputs to functions other than the navigation updating module 330. For example, a predictive actuation validator, task-assignment module, object-manipulation controller, collaborative transport controller, spatial reservation module, or human-safety monitor may subscribe to semantic hazard updates from the shared mapping module 210. A common semantic hazard representation may therefore operate as an intermediate machine-readable control layer shared across multiple decision subsystems of the robot.

In FIG. 3B, the physical AI platform 240 includes sensors 340 for input from a real-world environment, processors 350 to execute general and inferencing tasks, memory 360 to store computer-executable instructions, communications interface 370 to receive and transmit data over a channel, and actuators 380 to manifest actions on the real-world environment.

Many other variations are possible.

### A. Hazard Detection and Semantic Labeling

A robot traversing an environment detects a physical hazard using one or more onboard sensors 340, including but not limited to cameras, lidar, radar, depth sensors, inertial measurement units, tactile sensors, or wheel-slip detection systems. In some embodiments, hazards correspond to transient, dynamic, or non-geometric conditions not reliably captured by conventional geometric mapping systems. Such hazards may include, without limitation, dropped payloads, temporary aisle obstructions, maintenance zones, human congestion, wet floor or spill areas, pop-up no-go zones, or newly traversable shortcuts that emerge during operation.

Upon detection, the semantic analysis module 220 assigns a semantic label to the hazard. In one case, the hazard is absent from an existing internal map that was previously downloaded, built from traversals, or received from other robot encounters. In another case, the hazard is updated with richer parameters, reclassified to a hazard from non-hazard data or from one type of hazard to another, or further abstracted to a group or pattern of hazards in a specific area. Semantic processing can be performed locally with edge inferencing in a local GPU storing a small language model, or performed remotely at a data center.

In some embodiments, semantic labeling is performed using a machine-learned model trained to classify environmental features based on sensor input. In other embodiments, rule-based or hybrid classification systems may be used. Single modal or multi-modal inputs are possible. For example, a camera can receive images, a microphone can receive related audio, and a tactile component can receive pressure, weight, wetness, rigidity, or other physical characteristics. The data modalities can be combined to infer dimensions, context, permanency, and other hazard aspects. For instance, an object recognition can recognize a living creature from computer vision while an audio recognition can narrow down a type of creature from computer hearing. Further, the object can be manipulated to a different position or the robot can move to a different position to gain further insights.

The semantic label enables a receiving robot 102A, 102B to interpret the hazard in terms of operational constraints rather than requiring reconstruction of the hazard from raw data. For instance, a hazard policy may be referred to that provides rules for identified hazards. A cloud-based resource, such as a large language model, search engine, or database can provide further data for interacting with labeled hazards.

In some embodiments, semantic hazard data is represented across multiple levels of abstraction. A first level may include a direct descriptive label associated with a sensed condition, while higher levels may include abstracted classifications, behavioral constraints, policy-level directives, or task-level implications derived from the underlying label. For example, a detected spill may be abstracted to a reduced-traction constraint for locomotion planning, to a restricted-manipulation region for object handling, or to a remediation event for task allocation. Such hierarchical semantic representations enable flexible integration of hazard data across heterogeneous navigation, control, and coordination architectures.

In some embodiments, the semantic hazard layer is architecturally separate from geometric map representations maintained by the robot and can be shared. The semantic hazard layer may store semantic labels, policy attributes, severity values, temporal validity parameters, and other hazard-related metadata in a representation that is independently updateable, queryable, and consumable by downstream decision layers without requiring regeneration of a geometric occupancy structure. In this manner, the semantic hazard layer may function as a distinct semantic control substrate within the robot even when the robot also maintains one or more geometric, topological, or localization-oriented map representations.

Following semantic labeling, the robot stores the hazard as updates to historical semantic map data including a semantic label and spatial coordinates corresponding to the hazard location. Additional attributes such as confidence score, severity, timestamp, spatial extent, navigation constraints, and policy attributes may also be included. In some embodiments, policy attributes define safety, compliance, or operational constraints for the corresponding region, object, or condition, including without limitation a maximum permitted speed, a restricted payload type, a prohibition on manipulation, a limitation on actuator force, a reduced-capability operating mode, a human-clearance requirement, or a restricted-access designation. In some cases, temporary hazards are deleted after a certain time period, while in other cases the hazard metadata is retained and updated over time.

In some embodiments, the historical semantic map data further includes a temporal validity parameter, decay function, expiration rule, freshness score, spatial extent, or temporal occupancy interval associated with a given hazard entry. Such metadata enables the receiving robot, or a later receiving robot in a propagation chain, to reduce confidence in stale hazard data, expire transient hazards after a threshold time, maintain persistent hazards longer when corroborated by repeated observations, and reason about where and when the hazard is expected to affect operation. Accordingly, the disclosed semantic hazard layer may distinguish between persistent environmental conditions and temporary or event-driven operational hazards, and may support spatiotemporal reasoning concerning expected hazard duration, movement, expansion, or clearance.

In some embodiments, a robot computes a dynamic safety score for a current or planned operating region based at least in part on semantic labels, severity values, confidence values, policy attributes, or temporal validity parameters associated with one or more semantic map entries. The dynamic safety score may be used to determine whether to enable, disable, or modify one or more autonomous functions, including high-speed navigation, manipulation, close-proximity human interaction, or cooperative transport, even when the robot does not fully reroute around the referenced region. In this way, semantic hazard map data supports adaptive safety envelopes and behavior modification that is decoupled from path planning alone.

Unlike conventional map-sharing systems that transmit dense geometric maps or raw sensor observations, the disclosed system may maintain a semantic hazard layer as a compact representation that is directly actionable by downstream robotic subsystems. This reduces internal processing overhead and permits the semantic hazard layer to operate independently of one or more geometric, topological, or localization-oriented map structures maintained by the robot.

### B. Sharing Semantic Hazard Mapping During Robot Encounters

The system detects an encounter between the first robot 101A, 101B and the second robot 102A, 102B when the robots come within a defined proximity threshold. Proximity may be determined using communication signals (e.g., periodic beacons), computer vision, or other sensor-based detection. Upon detecting proximity, the robots establish a peer-to-peer communication link without routing communication through a centralized server. In one implementation, periodic beacons are transmitted from a robot transceiver which advertise map sharing capabilities, along with other services. When a beacon is acknowledged, it can be followed by a request for mapping data or an offer for mapping data, in either direction. Once mapping data is received, a compatible application can be invoked for taking action. Any appropriate protocol can be utilized for exchanges, such as a high-level physical AI communication protocol or a proprietary protocol for a specific vendor of a fleet of delivery robots. This distinguishes from conventional fleet-management systems and cloud robotics platforms, which rely on persistent connectivity to aggregate and redistribute environmental data. In contrast, the disclosed approach operates in environments lacking connectivity to centralized infrastructure, enabling direct exchange of information between robots in offline or intermittently connected environments.

During an encounter, the first robot 101A, 101B transmits at least a portion of its historical semantic map data to the second robot 102A, 102B. The transmission may be selective based on relevance criteria such as route overlap (i.e., predicted overlap or deterministic overlap), geographic proximity, recency, or hazard severity. Conventional vehicle-to-vehicle (V2V) or robot-to-robot communication systems typically exchange instantaneous state information, such as position, velocity, or intent, for collision avoidance or coordination. Such systems do not provide mechanisms for transferring historical, semantically labeled hazard data representing prior environmental observations. The disclosed system differs in that it transmits temporally persistent hazard knowledge derived from prior traversal, enabling the receiving robot to act on information that is not directly observable at the time of exchange.

In certain embodiments, the transmitted semantic hazard data excludes geometric map payloads and instead comprises compact, abstracted hazard descriptors that are directly consumable by the receiving robot's navigation or control logic without coordinate-frame reconciliation or full map fusion. The receiving robot may associate the received semantic descriptor with its own local coordinate frame, route representation, semantic scene graph, landmark set, or region model using route-relative, landmark-relative, object-relative, or region-relative matching rather than requiring alignment to a shared global map. This approach reduces transmission and processing burden while enabling interoperability among heterogeneous robots having different map representations, localization stacks, sensor modalities, or semantic models.

In certain embodiments, the system determines that the second robot 102A, 102B is traveling along a trajectory that intersects or reverses a path previously traversed by the first robot 101A, 101B, or the system predicts that the second robot will encounter the hazard. The semantic hazard data transmitted 199A, 199B by the hazard data messaging module 310 during such encounters is therefore relevant to the anticipated future path of the second robot 102A, 102B.

In some embodiments, semantic hazard data is used as an input to a decentralized negotiation protocol executed between proximate robots. Upon identifying a shared hazard region, conflicting traversal condition, or competing use of a constrained area, the robots may negotiate traversal order, route selection, timing adjustments, or task delegation based on factors including task urgency, robot capability, hazard severity, energy state, predicted risk exposure, or applicable policy attributes. The negotiation may be performed without a centralized coordinator and may result in dynamic prioritization, coordinated yielding, or hazard-aware redistribution of local responsibilities among heterogeneous robots.

Upon receiving semantic hazard data, the second robot 102A, 102B uses the hazard analysis and policy module 320 to update its local navigation model. This may include modifying traversability scores, cost maps, or route constraints associated with the hazard location. Unlike conventional systems that require integration of full maps or reprocessing of raw sensor data, the disclosed system enables direct incorporation of semantic hazard information into the navigation model, thereby reducing computational overhead and enabling rapid adaptation.

Following the update, the navigation updating module 330 can modify its planned route prior to reaching the hazard location, as necessary. The modification is predictive rather than reactive, as it is based on hazard information obtained from another robot rather than direct sensing. The modification can include avoidance through alternative routing, or can include specific guidance for interacting with the hazard (e.g., suggested speed or torque). For instance, the second robot 102A, 102B may change course to a longer route with fewer anticipated hazards. In another example, the second robot 102A, 102B may have better capabilities than the first robot, allowing the second robot 102A, 102B to ignore what is hazardous to the first robot 101A, 101B. Accordingly, a curb that was considered high for a smaller robot may not be considered high for a larger robot having larger tires and a better balancing system.

In some embodiments, the received semantic hazard data is used for preemptive behavioral adaptation prior to local sensor detection of the hazard by the receiving robot. Such adaptation may include route modification, speed reduction, mode switching, safety-margin expansion, actuator-force limitation, alternate gait selection, or invocation of a higher-confidence control policy. By acting on shared semantic hazard data before direct local perception of the hazard, the receiving robot 102A, 102B may reduce reaction latency, avoid redundant sensing or computation, and improve safety in environments where the hazard is occluded, intermittent, socially dynamic, or weakly observable to the receiving robot's 102A, 102B own sensor stack.

In some embodiments, historical semantic map data includes temporal attributes that define a validity window. The receiving robot may adjust confidence levels or discard stale data accordingly. This temporal handling distinguishes from static map-sharing approaches that assume persistent validity of environmental data.

In certain embodiments, semantic hazard data is propagated across multiple robots through a daisy chain of successive peer-to-peer encounters, thereby enabling distributed dissemination of environmental knowledge without centralized coordination and without direct interaction with an originating robot. Propagated semantic hazard data may retain provenance, authorship, lineage, or trust metadata identifying an originating robot, one or more intermediate relay robots, corroborating observations, confidence evolution, or source-reputation values. A receiving robot may evaluate such metadata to determine whether to accept, down-weight, quarantine, reject, or further propagate a particular semantic hazard entry, and reputation values may be updated over time based on agreement or disagreement between transmitted hazard data and subsequently observed conditions.

In some embodiments, the semantic hazard layer is used not only to represent observed hazards, but also to represent predicted or forecasted hazards. A robot may generate a semantic hazard entry corresponding to an anticipated future condition, such as projected human congestion, expected occupancy of a route segment, anticipated movement of another robot, probable instability of a carried payload, forecasted spill spread, or a likely traversability change. Such predictive hazard entries may be assigned confidence and temporal forecast parameters and shared with peer robots in the same manner as observed hazards, thereby enabling distributed forecasting and anticipatory coordination across a robotic swarm.

In some embodiments, a receiving robot 102A, 102B may receive conflicting hazard data from multiple robots or data that conflicts with its own observations. The system may resolve such conflicts using confidence weighting, recency weighting, source reliability, corroboration by additional robots, quorum logic, peer-to-peer voting, reputation-weighted selection, cryptographic attestation, or swarm consensus to determine a resolved semantic representation or a confidence-ranked set of candidate representations for a given region or hazard condition.

### C. Robot Hardware Architecture and Computing Environment

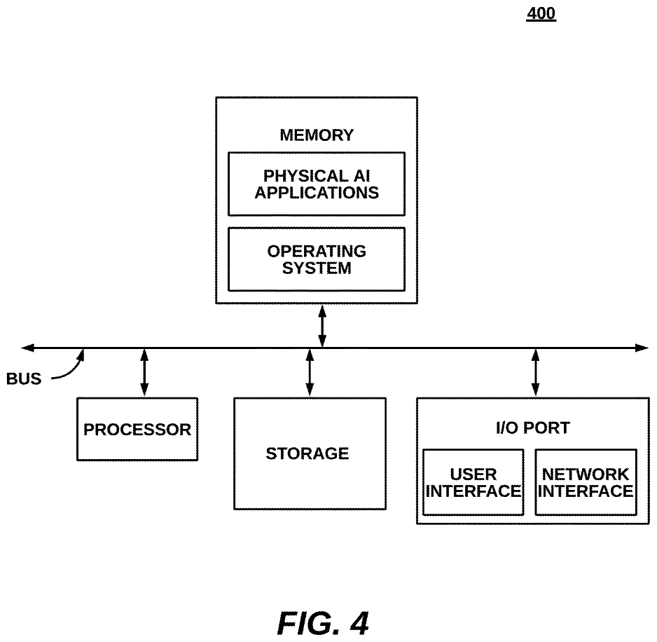

In FIG. 4, a block diagram illustrates a computing environment 400 (e.g., physical AI platform 240) for components of semantic hazard map sharing. Each autonomous robot comprises a hardware and software computing environment configured to support physical AI operations, including perception, semantic interpretation, decentralized communication, and motion planning. The computing environment 400 may include one or more processors, such as general-purpose CPUs, graphics processing units (GPUs), neural processing units (NPUs), network processing units, application-specific integrated circuit (ASIC), or other parallel processing architectures, coupled to memory storing executable instructions and data structures, including operating systems and physical AI applications. The system further includes multi-modal sensor interfaces (e.g., vision, depth, lidar, radar, inertial, tactile), communication interfaces supporting peer-to-peer wireless protocols (e.g., Wi-Fi Direct, Bluetooth, ultra-wideband, mesh networking), and actuator control systems for executing physical actions. In some embodiments, the computing environment supports disaggregated AI execution, wherein lightweight on-device models perform real-time inference while selectively interfacing with remote or distributed resources when available. The architecture is configured to operate in offline or intermittently connected environments, enabling decentralized decision-making without reliance on centralized servers, and supports storage and exchange of semantically encoded environmental data structures for use in predictive navigation and coordination tasks.

In some embodiments, the computing environment further includes one or more policy engines, validator modules, or model-routing modules configured to consume semantic hazard data as control inputs. Such modules may use the semantic hazard data to select among multiple control policies, invoke a local small language model or a remote larger model, trigger an actuation gate, elevate a safety mode, or reallocate a task among robots. Thus, the disclosed semantic hazard-sharing system may act as a common upstream semantic substrate for both navigation and non-navigation robotic behaviors.

In embodiments involving humanoid robots, the computing environment further supports articulated motion control, balance, and manipulation tasks associated with bipedal or multi-limbed locomotion. The system may integrate joint-level control systems, force-feedback sensors, and dynamic stability models to coordinate movement across multiple degrees of freedom. Semantic hazard data may be utilized not only for macro-routing, but also to adjust local motion planning, gait planning, object interaction strategies, or human-aware navigation behaviors. For example, a humanoid robot receiving advance semantic warning of a slippery surface, unstable foothold, deformable region, or obstructed pathway may preemptively adjust foot placement, stride selection, center-of-mass trajectories, joint torque limits, balance-recovery parameters, or manipulation sequences prior to direct local sensing of the hazard. Similarly, a wheeled or tracked robot may adjust wheel torque, steering behavior, traction-control settings, suspension responses, or speed envelopes in response to a received semantic hazard descriptor. In this manner, the semantic hazard layer may influence physical traversal and interaction behavior even where a robot does not select a full spatial detour. The decentralized communication framework enables humanoid robots operating in shared human environments to exchange contextual hazard knowledge without requiring centralized coordination, improving safety and adaptability.

In embodiments involving autonomous vehicles, including ground-based delivery robots and passenger or industrial vehicles, the computing environment supports route planning, obstacle avoidance, and environment mapping across structured or semi-structured environments. The system may integrate vehicle control systems, localization modules (e.g., GPS, visual odometry, SLAM variants), and path-planning engines configured to utilize semantic hazard data received from peer robots. The decentralized architecture enables vehicles to share information such as road hazards, temporary obstructions, or surface conditions directly when in proximity, particularly in environments where connectivity to centralized fleet systems is unavailable or degraded. The received semantic data may be incorporated into cost maps, route optimization algorithms, or predictive models to modify navigation behavior prior to encountering the hazard.

In embodiments involving aerial drones, submersible robots, or other non-terrestrial robotic systems, the computing environment is adapted to operate under domain-specific constraints such as limited bandwidth, dynamic environmental conditions, and three-dimensional navigation spaces. The system may include specialized sensors (e.g., sonar for underwater systems, altimeters for aerial systems), environmental modeling components, and control systems for propulsion and stabilization. Decentralized peer-to-peer communication enables exchange of semantically labeled environmental features such as turbulent zones, obstacles, or hazardous regions that may not be directly observable by other robots. In underwater or remote environments where centralized communication infrastructure is impractical, the disclosed approach enables distributed propagation of navigational intelligence across robotic agents, improving mission success rates and operational safety.

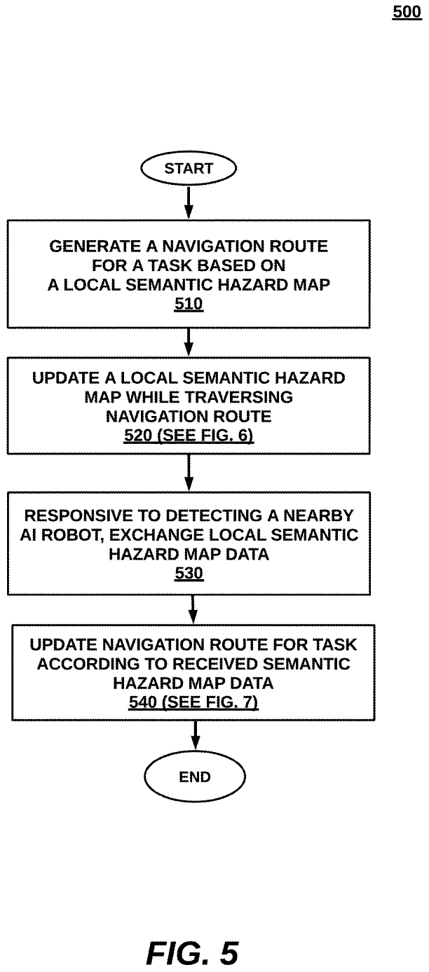

### II. Methods for Decentralized Semantic Hazard Propagation (FIGS. 5-7)

It will be appreciated that the methods described herein are illustrative and not limiting. The steps of the disclosed methods may be performed in any suitable order, and in some embodiments, one or more steps may be omitted, combined, repeated, or performed concurrently. Additional steps may be included without departing from the scope of the present disclosure. Further, individual steps may be implemented using one or more processing components, modules, or distributed systems, and may be carried out in hardware, software, or any combination thereof. Accordingly, the particular sequencing and grouping of steps described herein are provided for clarity of explanation and are not intended to require strict adherence in all embodiments.

### A. AI-Driven Routing for Robot Navigation

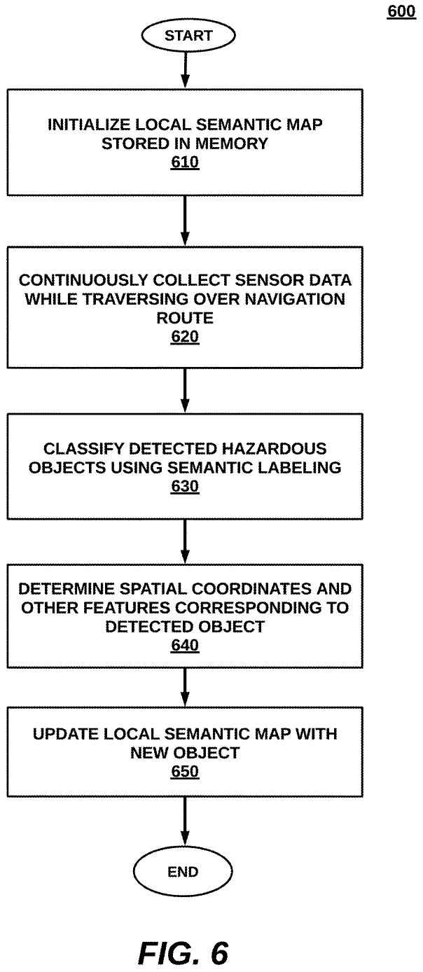

Referring to FIG. 5, a method 500 is illustrated for heterogeneous AI robots exchanging semantic mapping data during task execution, navigation, and decentralized coordination. At step 510, a navigation route is generated based at least in part on local semantic map data. The navigation route may be derived from a task or workflow, such as delivering a payload to an address or performing an aerial survey. In some embodiments, semantic hazard map data is used for task planning and task assignment prior to generation of the navigation route. A task allocator may evaluate candidate tasks based on associated regions, routes, or destinations and compute a task feasibility score for each robot using semantic labels, severity values, policy attributes, temporal validity parameters, capability-match criteria, or predicted hazard exposure present in local or shared semantic hazard maps. Other data inputs can include a downloaded street map, weather conditions, traffic density, historical navigation routes, battery power, robot capabilities, and the like. At step 520, a local semantic hazard map is updated while traversing the navigation route (see FIG. 6).

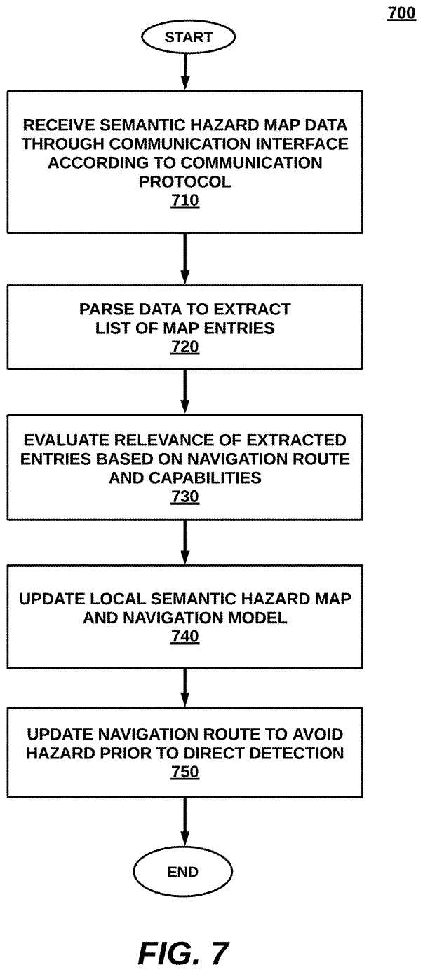

Upon detecting a nearby robot, at step 530, semantic mapping data is exchanged (or just received)(see FIG. 7). The robot evaluates new hazards from semantic mapping data and updates navigation, as needed, at step 540.

In other embodiments, non-hazardous semantics are analyzed and mapped. In yet other embodiments, semantics are used for purposes other than navigation.

### B. Building a Local Semantic Hazard Map

Referring to FIG. 6, a method 600 is illustrated for generating and maintaining a local semantic map based on environmental observations, according to an embodiment of step 520 of FIG. 5.

At step 610, an autonomous robot initializes a local semantic map data structure stored in memory. The default map data can be downloaded during updates and also include past semantic mapping from its own traversals, or as learned from other robots during exchanges.

At step 620, the autonomous robot navigates through an environment while continuously collecting sensor data from one or more onboard sensors. The autonomous robot processes the sensor data to detect environmental features, including potential hazards or navigation-relevant conditions. At step 630, the autonomous robot classifies detected features using a semantic labeling process to assign one or more semantic labels representing functional characteristics of the detected features. At step 640, the autonomous robot determines spatial coordinates corresponding to each detected feature within a local or global reference frame.

At step 650, the autonomous robot generates and stores a semantic map entry in the local semantic map, the semantic map entry comprising the semantic label, spatial coordinates, and optionally additional attributes including confidence values, severity levels, timestamps, or spatial extents. Optionally, the autonomous robot updates or refines existing semantic map entries based on subsequent observations, including reclassification, confidence adjustment, or removal of stale data.

The method repeats continuously during operation of the autonomous robot.

### C. Updating Navigation based on Shared Semantic Hazard Maps

Referring to FIG. 7, a method 700 is illustrated for updating a local semantic map using semantic mapping data received from other robots, according to an embodiment of step 530 of FIG. 5.

At step 710, a first autonomous robot receives semantic map data from a second autonomous robot via a peer-to-peer communication link established during a proximity-based encounter.

At step 720, the first autonomous robot parses the received semantic map data to extract one or more semantic map entries, each including a semantic label and spatial coordinates.

At step 730, the first autonomous robot evaluates the received semantic map data for relevance based on criteria including geographic proximity, predicted traversal path, temporal validity, confidence level, policy relevance, or task relevance. In one embodiment, the first autonomous robot determines whether the received semantic map data conflicts with existing entries in the local semantic map. In response to detecting a conflict, the first autonomous robot resolves the conflict using one or more resolution strategies including confidence weighting, recency prioritization, source reliability, corroboration by additional robots, or consensus logic.

At step 740, the first autonomous robot integrates the received semantic map data into the local semantic map by adding new entries or updating existing entries. In some embodiments, the first autonomous robot further uses the received semantic map data to modify a navigation model, a safety policy, a control policy, a task assignment state, or a coordination state associated with one or more local or shared robotic activities. The first autonomous robot may thereby modify traversability costs, route constraints, path-planning parameters, operational safety envelopes, or task feasibility determinations associated with the hazard.

At step 750, the first autonomous robot modifies a planned route based on the updated navigation model to avoid or appropriately interact with the hazard prior to direct detection.

During subsequent interactions, the first autonomous robot propagates the received semantic map data to additional robots through subsequent peer-to-peer encounters.

### III. Generalities

The foregoing description of embodiments of the present disclosure has been presented for purposes of illustration and description and is not intended to be exhaustive or to limit the disclosure to the precise forms disclosed. Many modifications, variations, and alternative implementations will be apparent to those of ordinary skill in the art in light of the above teachings. For example, although certain embodiments are described in the context of ground-based delivery robots, the disclosed systems and methods are equally applicable to aerial, submersible, humanoid, or other autonomous systems operating in diverse environments. Similarly, while peer-to-peer encounter-based communication is emphasized, aspects of the disclosure may be combined with hybrid architectures including intermittent centralized coordination or infrastructure-assisted communication.

Therefore, the scope of the invention is defined by the appended claims and their equivalents, rather than by the specific embodiments described herein.

I claim:

1. A method for decentralized sharing of environment data between autonomous robots, comprising:
navigating, by a first autonomous robot, along a first path and detecting a physical hazard;
assigning, by the first autonomous robot, a semantic label to the detected physical hazard and storing a labeled location as historical semantic map data;
detecting, by the first autonomous robot, proximity to a second autonomous robot in an environment lacking connectivity to a centralized server; and
transmitting, directly from the first autonomous robot to the second autonomous robot via a peer-to-peer communication link and without reliance on a centralized controller, at least a portion of the historical semantic map data comprising the semantic label and spatial coordinates of the detected physical hazard,
wherein the historical semantic map data is configured to enable modification of a navigation model of the second autonomous robot to avoid the physical hazard prior to encountering the physical hazard.

2. The method of claim 1, wherein the second autonomous robot is navigating along a trajectory that intersects or reverses the first path.

3. The method of claim 1, wherein the historical semantic map data further comprises a confidence value, severity value, or timestamp associated with the physical hazard.

4. The method of claim 1, wherein transmitting comprises filtering the historical semantic map data based on route relevance or predicted path overlap.

5. The method of claim 1, wherein updating the local navigation model comprises modifying a traversability cost associated with a region containing the physical hazard.

6. The method of claim 1, wherein the peer-to-peer communication link comprises a short-range wireless connection.

7. The method of claim 1, wherein modifying the planned route comprises selecting an alternate path that avoids the physical hazard.

8. The method of claim 1, wherein the semantic label identifies a hazard type used to determine a navigation constraint.

9. The method of claim 1, wherein the environment lacks connectivity to both a centralized server and a cloud-based mapping service.

10. The method of claim 1, wherein the historical semantic map data is propagated across multiple robots through successive peer-to-peer encounters.

11. The method of claim 1, wherein the historical semantic map data excludes geometric map representations and comprises abstracted hazard descriptors directly consumable by a navigation model without reconstruction of an underlying geometric map.

12. The method of claim 1, wherein transmitting the historical semantic map data is triggered based on detection of proximity between the first autonomous robot and the second autonomous robot and a determination that a predicted traversal path of the second autonomous robot intersects or overlaps with the first path.

13. The method of claim 1, wherein the historical semantic map data includes a temporal validity parameter associated with the physical hazard, the temporal validity parameter causing expiration, decay, or reduction in confidence of the physical hazard over time.

14. The method of claim 1, wherein modification of the navigation model of the second autonomous robot occurs prior to local sensor detection of the physical hazard by the second autonomous robot.

15. The method of claim 1, wherein transmitting the historical semantic map data is performed without requiring coordinate frame alignment, map fusion, or reconciliation of geometric representations between the first autonomous robot and the second autonomous robot.

16. The method of claim 1, wherein the historical semantic map data further comprises at least one of: a hazard severity indicator, a confidence value, a timestamp, a spatial extent, or a recommended traversal constraint.

17. A method for decentralized semantic state sharing in a multi-robot system, comprising:
detecting, by a first autonomous robot, an environmental condition in an environment;
generating, by the first autonomous robot, semantic state data representing the environmental condition, the semantic state data comprising at least a semantic label and location-associated data for the environmental condition;
detecting, by the first autonomous robot, proximity to a second autonomous robot in an environment lacking connectivity to a centralized server;
transmitting, directly from the first autonomous robot to the second autonomous robot via a peer-to-peer communication link and without reliance on a centralized controller, at least a portion of the semantic state data; and
using, by the second autonomous robot, the semantic state data to modify an operational state of the second autonomous robot,
wherein the operational state comprises at least one of a navigation state, a control policy state, a safety policy state, a task assignment state, a candidate action state, or a coordination state.

18. An autonomous robotic system, comprising:
one or more processors;
a memory storing instructions;
one or more sensors configured to detect environmental conditions;
a communication interface configured to establish a peer-to-peer communication link with another autonomous robot; and
a shared mapping module executable by the one or more processors and configured to:
detect a physical hazard based on sensor data;
assign a semantic label to the detected physical hazard and store a labeled location as historical semantic map data;
detect proximity to a second autonomous robot in an environment lacking connectivity to a centralized server;
transmit, via the communication interface and without reliance on a centralized controller, at least a portion of the historical semantic map data to the second autonomous robot;
wherein the historical semantic map data excludes geometric map representations and comprises abstracted hazard descriptors directly consumable by a navigation model without reconstruction of a geometric map; and
wherein the transmitted historical semantic map data is configured to cause the second autonomous robot to modify a navigation model prior to local detection of the physical hazard and without requiring coordinate frame alignment or map fusion.

19. The system of claim 18, wherein transmission of the historical semantic map data is triggered based on detection of proximity and a determination of predicted path intersection between the autonomous robotic system and the second autonomous robot.

20. The system of claim 18, wherein the historical semantic map data includes a temporal validity parameter that causes expiration or degradation of the physical hazard based on elapsed time or environmental context.
